(19) United States
(12) Patent Application Publication
(10) Pub. No.: US 2006/0170668 A1
(43) Pub. Date: Aug. 3, 2006

(54) Monitor circuit board

(75) Inventor: Wen-Sen Hsieh, Taoyuan City (TW)

Correspondence Address: TROXELL LAW OFFICE PLLC, SUITE 1404, 5205 LESSBURG PIKE, FALLS CHURCH, VA, 22041, US

(73) Assignee: SPI Electronic Co., Ltd.

(21) Appl. No.: 11/338,665

(22) Filed: Jan. 25, 2006

(30) Foreign Application Priority Data
Feb. 3, 2005 (TW) 094202028

(51) Int. Cl. G09G 5/00

(52) U.S. Cl. 345/211

(57) ABSTRACT

A circuit board in a monitor containing a switch unit to control the size of the amperage outputted to drive the corresponding monitor for the circuit board to adjust its outputted amperage by means of the switch unit depending on the size of the monitor to be adapted to.

### BACKGROUND OF THE INVENTION

(a) Field of the Invention

The present invention is related to an improved construction of a monitor circuit board, and more particularly, to one that varies output current depending on the size of the monitor.

(b) Description of the Prior Art

As illustrated in FIG. 1 of the accompanying drawings showing a rear view of a monitor 20 of the prior art connected to a power source, the monitor 20 contains a circuit board 10. The circuit board is connected to an external source converter or provided with a built-in source conversion module to convert the city power into DC source for supplying power to the circuit board 10, wherein in turn the current is outputted to and drive each tube (not illustrated) for the monitor 20 to display. Monitors generally available in the market are supplied in various sizes including 15″, 17″, 19″ or larger, etc., and fewer tubes for the smaller sizes. Therefore, the amperage to drive each tube also varies. However, the circuit board in the monitor receives input voltage and outputs fixed amperage to each tube. If change of the size of the monitor is desired, the circuit board in the monitor must be also replaced at the same time to not only require more efforts from the user but also compromise the utility of the circuit board.

### SUMMARY OF THE INVENTION

The primary purpose of the present invention is to provide an improved construction of a circuit board in a monitor by having provided a switch unit in the circuit board to control the size of the outputted amperage to drive the monitor depending on the size of the monitor to be adapted to. Wherein, the switch unit may be related to a jumper device comprised of four jumper pins and a jumper cap to facilitate adjustment of the amperage to be outputted.

### BRIEF DESCRIPTION OF THE DRAWINGS

FIG. 1 is a rear view showing a monitor of the prior art is connected to a power source.

FIG. 2 is a perspective view of a circuit board of the present invention.

FIG. 3 is a schematic view showing adjustment of a jumper device used in the present invention.

FIG. 4 is another schematic view showing adjustment of the jumper device used in the present invention.

### DETAILED DESCRIPTION OF THE PREFERRED EMBODIMENTS

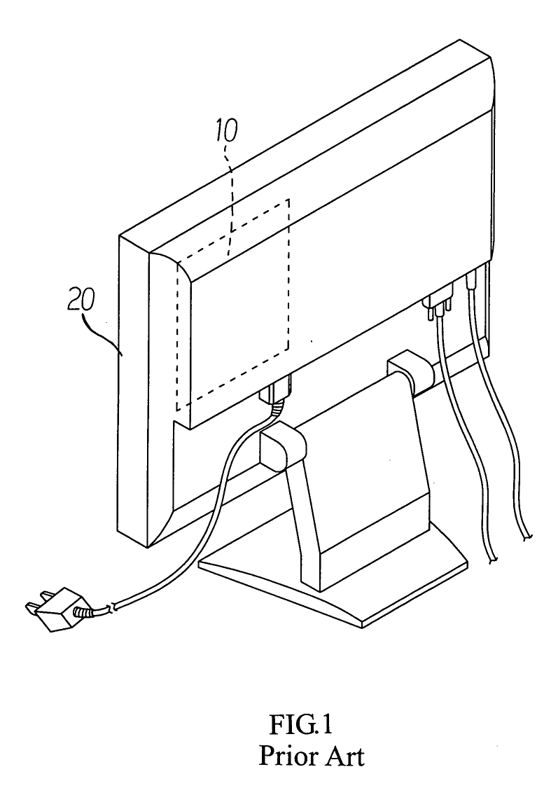

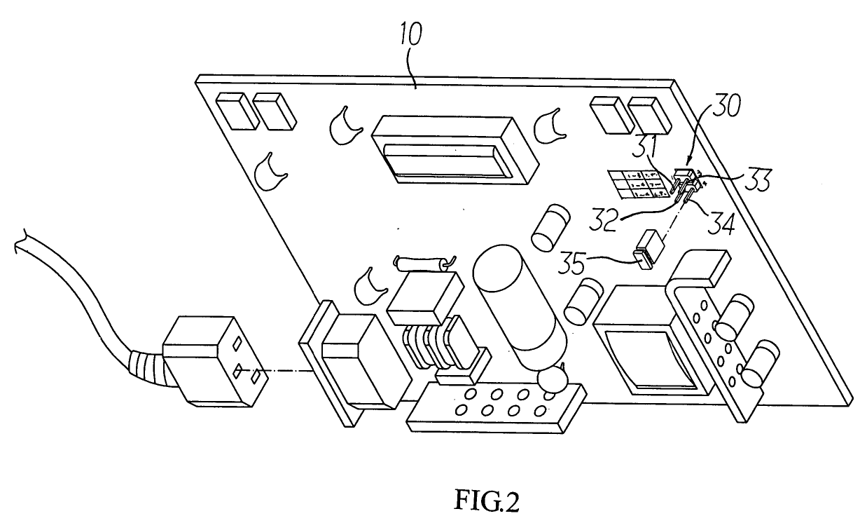

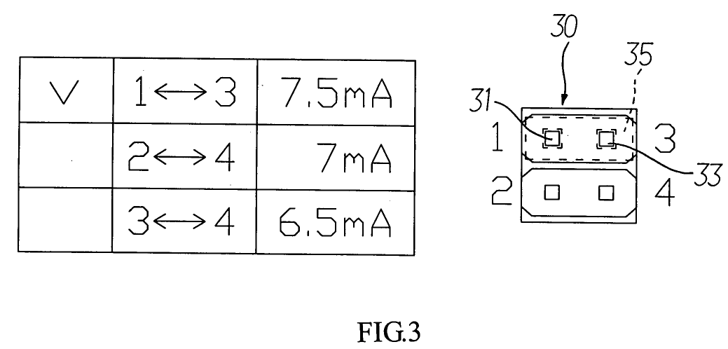

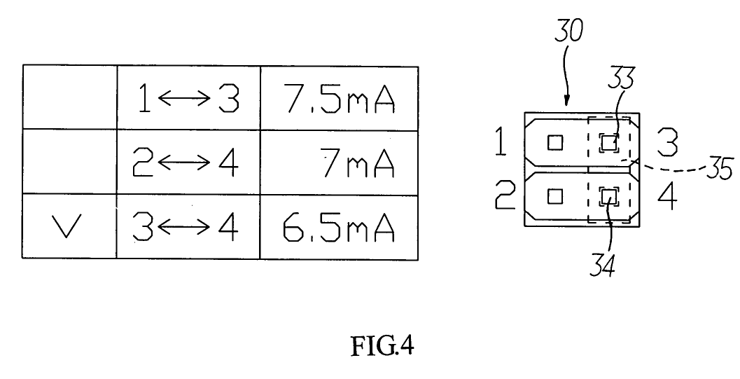

Referring to FIG. 1, a monitor 20 of the present invention also contains a circuit board 10. The circuit board 10 either is connected to an external source converter or has a built-in source conversion module to convert city power into DC source supplied to the circuit board 10, where in turn the current is outputted to drive each tube (not illustrated) of the monitor 20 for the monitor to display.

Wherein, a switch unit is disposed in the circuit board to control the size of the current outputted. As illustrated in FIG. 2, the switch unit is related to a jumper device 30 comprised of a first, a second, a third, and a fourth jumper pins 31, 32, 33, 34 and a jumper cap 35. Those four jumper pins 31, 32, 33, 34 are respectively comprised of a resistance circuit different from one another. The adjustment of the amperage outputted is done by referring to the amperage outputted from the jumper device 30 depending on the amperage desired by the monitor. As illustrated in FIG. 3 for a preferred embodiment, in the assembly of a monitor of an amperage of 7.5 mA, the jumper cap 35 is placed on the first and the third jumper pins 31, 32 to short the first and the third jumper 31, 32, thus to produce a 7.5 mA feedback current to be outputted to drive each tube for the monitor to display. Alternatively as illustrated in FIG. 4, to assemble a monitor of 6.5 mA amperage, the jumper cap 35 covers the third and the fourth jumper pins 33, 34 for creating a shortage between the third and the fourth jumper pins 33, 34, thus to produce a feedback current of 6.5 mA.

By applying a simple switch unit, e.g., a jumper device, the present invention allows fast and easy adjustment of the amperage to be outputted for the circuit board to drive the monitor depending on the size of the monitor.

The prevent invention provides an improved structure of a monitor circuit board by allowing easy and fast manual adjustment of the size of the current outputted from the circuit board of the monitor, this application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I Claim:

1. A monitor circuit board contains a switch unit to control the size of the outputted amperage to drive a monitor depending on the size of the monitor.

2. The monitor circuit board of claim 1, wherein the switch unit is related to a jumper device comprised of a first, a second, a third, a fourth jumper pins and a jumper cap.

3. The monitor circuit board of claim 1, wherein, the first, the second, the third, and the fourth jumper pins are respectively comprised of a resistance circuit different from one another.

4. The monitor circuit board of claim 2, the circuit board is further connected to a source conversion module.
